(19) United States
(12) Patent Application Publication
(10) Pub. No.: US 2026/0189814 A1
(43) Pub. Date: Jul. 2, 2026

(54) image sensor and reading method thereof, and electronic device

(71) Applicant: SMARTSENS TECHNOLOGY(SHANGHAI) CO., LIMITED, Shanghai (CN)

(72) Inventors: Shengxin ZHANG, Shanghai (CN); Chen XU, Shanghai (CN); Guanjing REN, Shanghai (CN); Liming TANG, Shanghai (CN)

(73) Assignee: SMARTSENS TECHNOLOGY(SHANGHAI) CO., LIMITED, Shanghai (CN)

(21) Appl. No.: 18/864,904

(22) PCT Filed: Jun. 16, 2023
(86) PCT No.: PCT/CN2023/100724

§ 371 Date: Nov. 12, 2024

(51) Int. Cl. H04N 25/51; H04N 25/59; H04N 25/78

(52) U.S. Cl. CPC H04N 25/51; H04N 25/59; H04N 25/78

(57) ABSTRACT

An image sensor, comprising pixel units arranged in an array and at least one gain control circuit; each pixel unit comprises at least one photosensitive unit, a floating diffusion node, a gain control transistor, a source follower transistor, and a reset transistor; the photosensitive unit is connected to the floating diffusion node through a transmission transistor; in each pixel unit, the reset transistor is connected to the gain control transistor, which is connected to the floating diffusion node, the reset transistor and the gain control transistor are co-connected to a gate of the source follower transistor; of pixel units located in a same column, each X pixel units share one bit line; X*Y adjacent pixel units in the same column are read out via Y bit lines; each gain control circuit is connected to a drain of each gain control transistor in K pixel units in the same column.

### FIELD OF THE INVENTION

The present disclosure relates to the technical field of image sensors, and in particular to an image sensor and a reading method thereof, and an electronic device.

### BACKGROUND OF THE INVENTION

Image sensors, which are integral components of numerous electronic devices like smartphones, digital cameras, video surveillance systems, AI devices, facial recognition systems, drones, and more, are designed to capture and interpret images.

As advancements in process technology and pixel performance continue to evolve, there is a significant increase in the pixel full-well capacity of traditional image sensors; during the signal readout phase, a high conversion gain is typically employed to capture images in low light environments, while a low conversion gain is used for images in high light environments. However, as the pixel full-well capacity increases, there is a growing need for low conversion gains for high light environments.

As shown in FIG. 1, in an existing image sensor 10 having dual gain conversion, a plurality of pixel units 100 is arranged in an array, and all pixel units 100 in each column are read out through one bit line. All pixel units have the same circuit structure, as shown in FIG. 2, including: a photodiode PD, a transmission transistor M1, a floating diffusion node FD, a reset transistor M2, a gain control transistor M3, a source follower transistor M4, and a selector transistor M5. Furthermore, a capacitance Ca is provided between the reset transistor M2 and the gain control transistor M3, and the capacitance Ca may be a parasitic capacitance or a device capacitance.

The above-described pixel unit 100 has two conversion gain modes when in operation, namely a high conversion gain (HCG) mode and a low conversion gain (LCG) mode. Take any row of pixel units as an example:

In the HCG mode, the gain control transistor M3 is turned off, and a gain capacitance value of each pixel unit in this row is the capacitance value of the floating diffusion node of the pixel unit itself, that is, Cfd. At this time, the circuit operates in the HCG mode, and images in low light environments can be captured.

In the LCG mode, the gain control transistor M3 is turned on, and the charge storage capacity is enhanced by including the capacitance Ca, so that the gain capacitance value of each pixel unit in this row is the sum of the capacitance value of the floating diffusion node of the pixel unit itself and the capacitance Ca, i.e., Cfd+Ca. At this time, the circuit operates in the LCG mode, and images in high light environments can be captured.

Existing image sensors can realize a large dynamic range by having the HCG mode and the LCG mode, but the pixel full-well capacity in the LCG mode is fixed and cannot be adjusted for different high light environments. Consequently, as the demand for high light environments progressively increases, the refinement of their output images struggles to keep up.

In addition, the pixel units 100 in the same column are read out through the same bit line. When multiple frames are being read out, there is a time difference between the reading processes for different frames, which can cause a trailing phenomenon in the final composite image. Moreover, the circuit's readout noise is significant.

### SUMMARY OF THE INVENTION

The present disclosure provides an image sensor and a reading method thereof, and an electronic device.

The image sensor includes pixel units arranged in an array and at least one gain control circuit.

Each of the pixel units comprises at least one photosensitive unit, a floating diffusion node, a gain control transistor, a source follower transistor, and a reset transistor, wherein the photosensitive unit is connected to the floating diffusion node through a corresponding transmission transistor; wherein in each pixel unit, the reset transistor is connected to the gain control transistor, which is connected to the floating diffusion node, and the reset transistor and the gain control transistor are co-connected to a gate of the source follower transistor.

Of the pixel units located in a same column, each X pixel units share one bit line, and X*Y adjacent pixel units in the same column are read out via Y bit lines, wherein X is an integer greater than or equal to 1, and Y is an integer greater than or equal to 2.

Each gain control circuit is connected to a drain of each gain control transistor in K pixel units in the same column, wherein K is an integer greater than or equal to 2.

Optionally, each gain control circuit comprises (K−1) segments of connecting lines, and the (K−1) segments connect the drain of each gain control transistor in the K pixel units sharing this gain control circuit.

Optionally, at least one of the (K−1) segments of connecting lines is provided with one or more switching transistors.

Optionally, when K is an even number, in each column, of the (K−1) segments of connecting lines, only the one connecting a (K/2)th pixel unit and a (K/2+1)th pixel unit is provided with the one or more switching transistors.

Optionally, each of the (K−1) segments of connecting lines is provided with the one or more switching transistors.

Optionally, in a direction perpendicular to the pixel units, an orthographic projection of connecting lines and an orthographic projection of the photosensitive unit are overlapped, and an overlapping ratio thereof is not greater than 50%.

Optionally, each K pixel units in the same column constitutes a first pixel group, and each first pixel group corresponds to one of the at least one gain control circuit respectively.

Optionally, each X*Y pixel units in the same column constitutes a second pixel group, and pixel units in each second pixel group are connected to the same bit line.

Optionally, when each pixel unit comprises a plurality of photosensitive units, the plurality of photosensitive units of each pixel unit receives light of the same color, wherein each plurality of photosensitive units constitutes one shared pixel unit.

Optionally, each pixel unit comprises four photosensitive units, and the four photosensitive units of each pixel unit are arranged in a 2×2 array; wherein each photosensitive unit comprises a photosensitive element and a transmission transistor, and the photosensitive element is connected to the corresponding floating diffusion node via the transmission transistor.

Optionally, each pixel unit further comprises a select transistor connected to a source of the source follower transistor.

In the method for reading an image sensor described above, image signals of K rows of pixel units are read row by row, wherein the image signals comprise reset signals and pixel signals.

Optionally, the method comprises: turning on the reset transistor and the gain control transistor in each pixel unit of a selected row of pixel units, to perform a reset operation on the floating diffusion node in each pixel unit of the selected row; turning off the gain control transistor in each pixel unit in the selected row and reading a reset signal of each pixel unit in the selected row; and turning on the transmission transistor in each pixel unit in the selected row, performing charge transfer and reading a pixel signal from each pixel unit in the selected row in a high conversion gain mode.

Optionally, the reset transistor in each pixel unit in the K rows of pixel units stays turned on all the time; the gain control transistor in each pixel unit in rows other than the selected row is turned on when the gain control transistor in each pixel unit in the selected row is turned off; wherein each pixel unit further comprises a selector transistor, wherein when reading the reset signal and the pixel signal of each pixel unit in the selected row, the selector transistor in each pixel unit in the selected row is turned on and the selector transistor in each pixel unit in the rows other than the selected row is turned off.

Optionally, the method comprises: turning on the reset transistor and the gain control transistor in each pixel unit in the selected row, turning off the gain control transistor in each pixel unit in rows other than the selected row, and performing a reset operation on the floating diffusion node in each pixel unit in the selected row; turning off the reset transistor in each pixel unit in the selected row and reading the reset signal of each pixel unit in the selected row; and turning on the transfer transistor in each pixel unit in the selected row, performing charge transfer and reading the pixel signal of each pixel unit in the selected row in a first low conversion gain mode.

Optionally, when each gain control circuit comprises one or more switching transistors, before performing a reset operation on the floating diffusion node in each pixel unit in the selected row, the method further comprises turning off all switching transistors.

Optionally, each pixel unit further comprises a selector transistor, and when reading the reset signal and the pixel signal of each pixel unit in the selected row, the selector transistor in each pixel unit of the selected row is turned on and the selector transistor in each pixel unit in rows than the selected row is turned off.

Optionally, the method comprises: turning on the gain control transistor in each pixel unit in the K rows of pixel units, turning on the reset transistor in each pixel unit in the selected row, and performing a reset operation on the floating diffusion node in each pixel unit in the selected row; turning off the reset transistor in each pixel unit in the selected row and reading the reset signal of each pixel unit in the selected row; and turning on the transfer transistor in each pixel unit in the selected row, performing charge transfer and reading the pixel signal of each pixel unit in the selected row in a Zth low conversion gain mode, wherein Z is an integer greater than or equal to K.

Optionally, when each gain control circuit comprises one or more switching transistors, before performing a reset operation on the floating diffusion node in each pixel unit in the selected row, the method further comprises turning on all switching transistors.

Optionally, each pixel unit further comprises a selector transistor, and when reading the reset signal and the pixel signal of each pixel unit in the selected row, the selector transistor in each pixel unit of the selected row is turned on and the selector transistor in each pixel unit in rows than the selected row is turned off; or the selector transistor in each pixel unit in the K rows of pixel units remains turned on.

The electronic device comprises the image sensor described above.

In summary, the presently disclosed image sensor, reading method thereof, and the electronic device introduce a wider ranges of low-conversion gains by having gain control circuits in the image sensor, with each of the gain control circuits connected to the drains of the gain control transistors of K pixel units in the same column; by controlling the amount of capacitance connected to the gain control transistor in each pixel unit of the image sensor in a LCG mode, the corresponding conversion gains are adjusted, thereby improve the dynamic range of the image sensor, and allowing it to output images that are more detailed in high light environments. The image sensor of the present disclosure has a higher image signal readout efficiency, and its circuit has a lower noise level, which can further improve the performance of the image sensor.

### BRIEF DESCRIPTION OF DRAWINGS

FIG. 1 is a schematic diagram of an image sensor in the prior art.

FIG. 2 shows a circuit diagram of a pixel unit of an image sensor in the prior art.

FIG. 3 shows a schematic structural diagram of an image sensor provided by the present disclosure.

FIG. 4 shows a schematic structural diagram of another image sensor provided by the present disclosure.

FIGS. 5-9 show circuit diagrams of pixel units in image sensors according to embodiments of the present disclosure, wherein only one of photosensitive units in each pixel unit is shown for the sake of simplicity.

FIGS. 10-12 show schematic structural diagrams of different numbers of photosensitive units in each pixel unit according to embodiments of the present disclosure.

FIGS. 13-16 show schematic diagrams of circuit layouts of image sensors according to embodiments of the present disclosure.

FIGS. 17-19 show schematic structural diagrams of another three image sensors according to embodiments of the present disclosure.

FIG. 20 shows a timing diagram of an image sensor provided by the present disclosure for reading an image signal in a high conversion gain mode.

FIG. 21 shows a timing diagram of an image sensor provided by the present disclosure for reading an image signal in a first low conversion gain mode.

FIG. 22 and FIG. 23 show timing diagrams of an image sensor provided by the present disclosure for reading an image signal in a Zth low conversion gain mode.

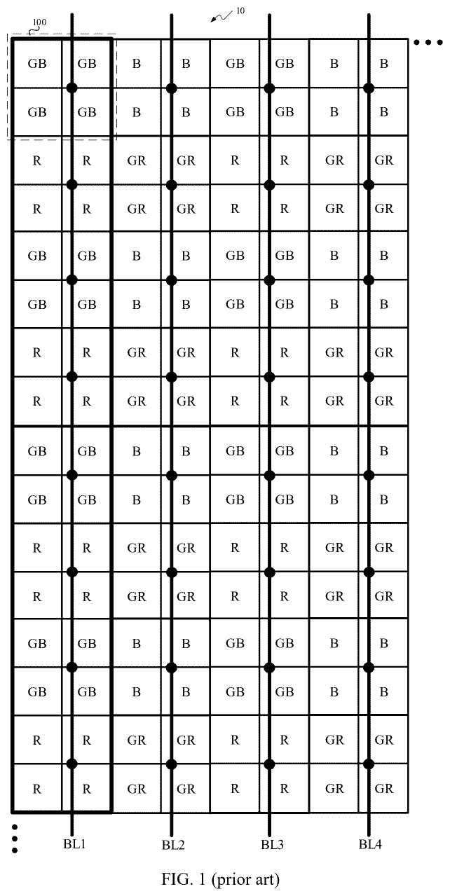

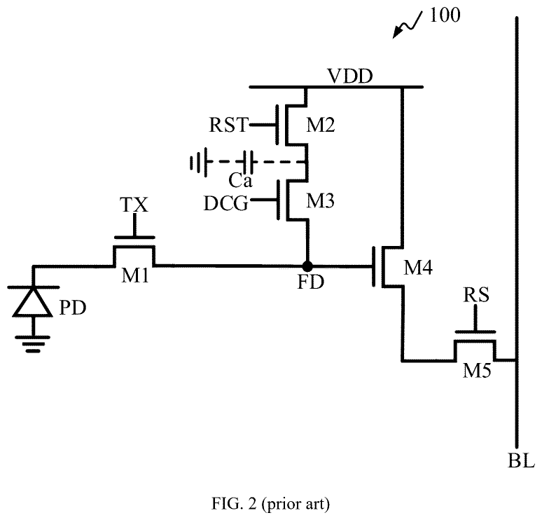

### REFERENCE NUMERALS

10 Image sensor
100 Pixel unit
101 Photosensitive unit
102 Orthographic projection of connecting lines
200 Gain control circuit

### DETAILED DESCRIPTION

The embodiments of the present disclosure will be described below. Those skilled can easily understand advantages and effects of the present disclosure according to contents disclosed by the specification. The present disclosure can also be implemented or applied through other different specific embodiments. Various details in this specification can also be modified or changed based on different viewpoints and disclosures without departing from the spirit of the CD present disclosure.

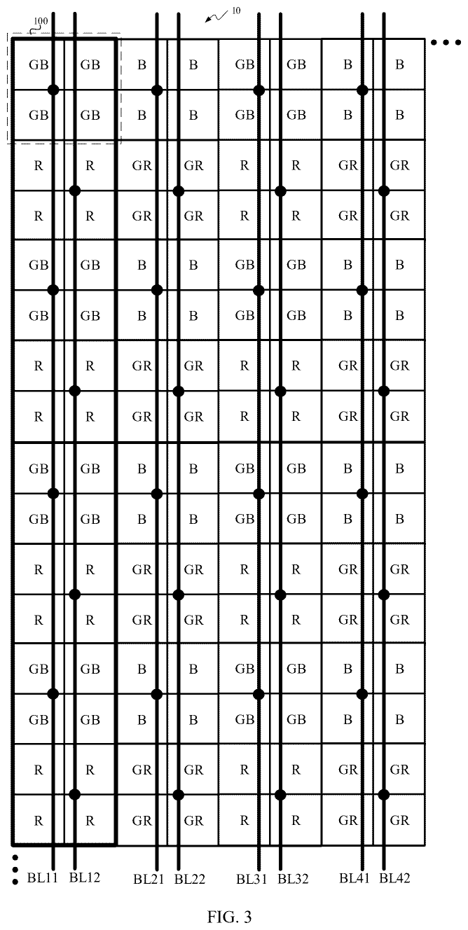

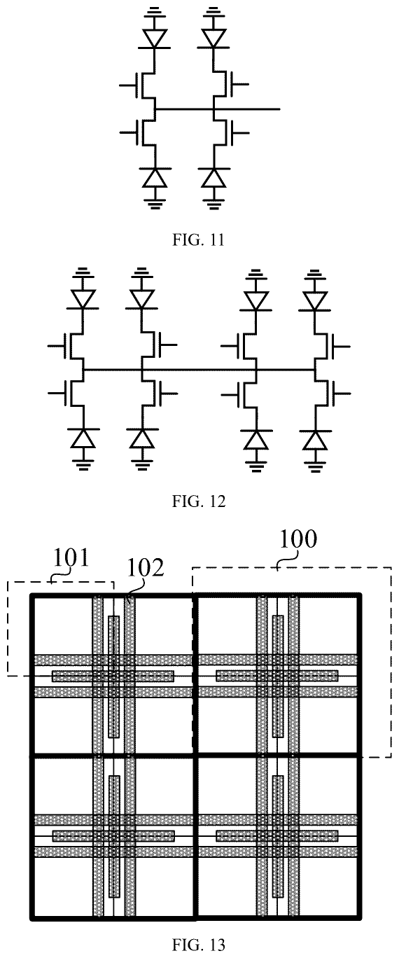

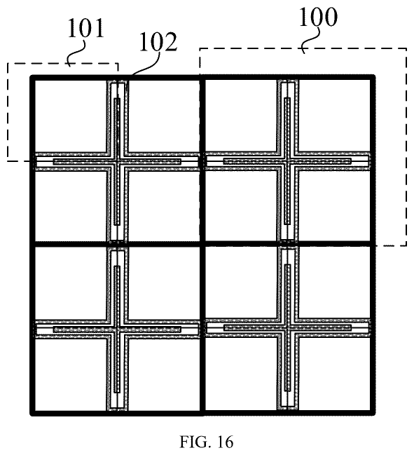

Refer to FIGS. 3 to 23. It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the layout of the components can also be more complicated.

### Embodiment 1

As shown in FIGS. 3-9, Embodiment 1 provides an image sensor 10 that includes a plurality of pixel units 100 arranged in an array and at least one gain control circuit 200. Each pixel unit 100 has the same circuit structure, including at least one photosensitive unit 101, a floating diffusion node (e.g., FD1), a reset transistor M2, a gain control transistor M3, and a source follower transistor M4. Further, each pixel unit 100 may include a select transistor M5.

Each photosensitive unit 101 is connected between the corresponding floating diffusion node (e.g., FD1) and a reference ground for generating charges based on the photoelectric effect, and transferring and outputting the charges. Specifically, each photosensitive unit 101 includes a photosensitive element PD and a transmission transistor M1, and the photosensitive element PD is connected to the floating diffusion node via the transmission transistor M1 (e.g., one end of the photosensitive element PD is connected to the reference ground, the other end is connected to the source of the transmission transistor M1, the gate of the transmission transistor M1 is connected to the transmission control signal TX1, and the drain of the transmission transistor M1 is connected to the floating diffusion node FD1); the photosensitive element PD converts an optical signal containing image information into electric charges based on the photoelectric effect, and the transmission transistor M1 is controlled to be turned on and output the charges by transferring them to the floating diffusion node FD1 in accordance with the transmission control signal TX1.

It is to be understood that “photosensitive element PD” referred to in the present disclosure may be any one of a photodiode, a grating, or an optical waveguide. Preferably, each photosensitive element PD is a photodiode, in which case the anode of the photodiode is connected to the reference ground and the cathode of it is connected to the source of the transmission transistor.

In practice, the number of photosensitive units 101 in each pixel unit 100 may be determined based on practical needs, such as 1, 2, 3, 4, 8, and so on. In the case where each pixel unit 100 includes only one photosensitive unit 101, the power consumption of the pixel unit 100 is lower, but correspondingly, its photoelectric conversion efficiency is lower. In the case where each pixel unit 100 includes more than one photosensitive unit 101, the different photosensitive units 101 are configured to receive light of the same color, and these photosensitive units 101 constitute one pixel unit, such that the filling factor of the pixel unit 100 is improved, thus improving the photoelectric conversion efficiency of the image sensor, as shown in FIGS. 10-12.

As an example, each pixel unit 100 includes four photosensitive units 101, and the four photosensitive units 101 are arranged in a 2×2 array, as shown in FIG. 11. The four photosensitive units of each pixel unit 101 may also be arranged horizontally or vertically in sequence instead of being arranged in a 2×2 array. As an example, the number of photosensitive units included in each pixel unit 100 may also be an odd number; having more photosensitive units in each pixel unit improves the photoelectric conversion efficiency of the image sensor 10.

As an example, the four photosensitive units 101 in the same pixel unit 100 are configured to receive light of the same color, which may be red (R), green (G, GR, or GB), or blue (B); in other examples, the four photosensitive units 101 may also be configured to receive white (W) light. Specifically, a color filter of a selected color is added to the light path corresponding to each pixel unit, thereby precisely allowing a narrow desired band of optical waves to pass through the photosensitive units of the pixel unit during the process of collecting light signals, and reflecting away other optical waves that are not desired.

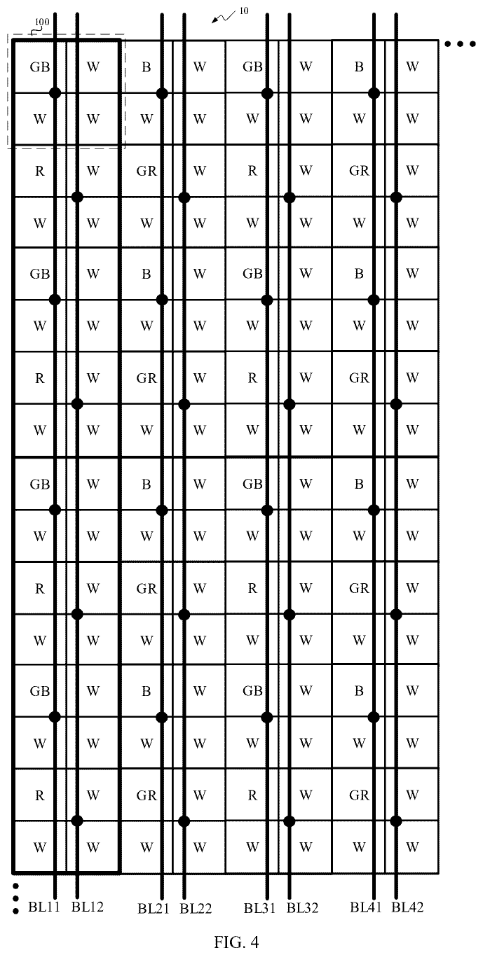

As an example, as shown in FIGS. 3 and 4, the pixel units 100 are divided into groups of four and each group is arranged in an array; for example, the group in the upper left corner of FIG. 3 includes four pixel units (a pixel unit receiving green light GB, a pixel unit receiving blue light B, a pixel unit receiving red light R, and a pixel unit receiving also green light GR), each including four photosensitive units receiving light of the same color; compared to FIG. 3, the embodiment of FIG. 4 introduces photosensitive units receiving white light W to each pixel unit. Receiving the additional white light W ensures the clarity of photographs taken in a low light environment when the image sensor 10 is in an operating state, and also helps to enhance the dynamic range of the image sensor 10.

The image sensor illustrated in FIG. 3 utilizes a conventional Bayer array arrangement of pixel units, i.e., the four pixel units 100 in each 2×2 pixel array receive red (R), green (GR), blue (B), and green (GR) light, respectively. In the image sensor illustrated in FIG. 4, in addition to white light (W), the four pixel units 100 in each 2×2 pixel array further receive red (R), green (GR), blue (B), and green (GR) light, respectively; note that the arrangement shown in FIG. 4 is exemplary, and other forms of pixel array arrangement may also be used.

Each floating diffusion node (e.g., FD1) includes a capacitor (e.g., Cfd1) for storing the charges obtained by transferring from the transfer transistor M1 and for realizing the charge-to-voltage conversion.

In each pixel unit 100, the reset transistor M2 is connected to the gain control transistor M3, which is connected to the floating diffusion node, and then they are co-connected to the gate of the source follower transistor M4. For example, the gate of the reset transistor M2 is connected to a reset control signal RST1, the drain of the reset transistor M2 is connected to a power supply VDD, and the source of the reset transistor M2 is connected to the drain of the gain control transistor M3; the gate of the gain control transistor M3 is connected to a gain control signal DCG1, and the source of the gain control transistor M3 is connected to the floating diffusion node FD1; the gate of the source follower transistor M4 is connected to the floating diffusion node FD1, the drain of the source follower transistor M4 is connected to the power supply VDD, and the source of the source follower transistor M4 outputs voltage signals (e.g., reset signals and pixel signals).

Further, in each pixel unit 100, the reset transistor M2 is used to reset the voltage of the floating diffusion node (e.g., FD1) according to the reset control signal (e.g., RST1), and it provides the voltage of the power supply VDD as the reset voltage when the gain control transistor M3 is turned on to realize the resetting of the voltage of the floating diffusion node.

In each pixel unit 100, the gain control transistor M3 is used to switch the pixel unit 100 between a high conversion gain (HCG) mode and a low conversion gain (LCG) mode; specifically, the gain control transistor M3 switches the pixel unit 100 to the HCG mode when the gain control transistor M3 is turned off and switches the pixel unit 100 to the LCG mode when it is turned on. It should be noted that in the image sensor of the present disclosure, there are more than one LCG mode, including, for example, a first low-conversion gain (LCG1) mode, a second low-conversion gain (LCG2), and so forth, which will be detailed below.

In each pixel unit 100, the source follower transistor M4 is used to transfer the voltage stored at the floating diffusion node (obtained by converting the charges transferred by the transfer transistor M1) to the source of the source follower transistor M4, which amplifies it before output. It should be noted that in the case where each pixel unit 100 does not include a selector transistor M5, the source of the source follower transistor M4 is connected to a corresponding bit line. When each pixel unit 100 includes a select transistor M5, the source of the source follower transistor M4 is connected to the drain of the select transistor M5.

As a preferred example, each pixel unit 100 includes the select transistor M5. The source of the source follower transistor M4 is connected to the drain of the select transistor M5. For example, in each pixel unit 100, the gate of the select transistor M5 is connected to a row selection signal (e.g., RS1), and the drain of the select transistor M5 is connected to the source of the corresponding source follower transistor M4 (i.e., the two transistors are in the same pixel unit 100), and the source of the select transistor M5 is connected to the corresponding bit line; the row selection signal RS1 is used to control the select transistor M5 to turn on, in order to select the voltage signal to be output by the source follower transistor M4. When a number of pixel units 100 of the same column in the image sensor 10 are required to output sequentially in a predetermined order, the sequential output can be achieved by turning on or off the select transistors M5 corresponding to these pixel units 100.

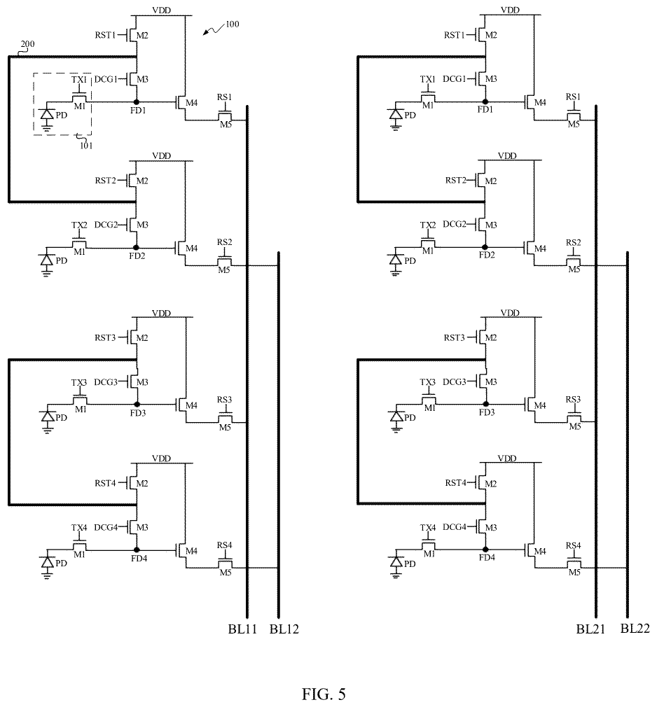

Each gain control circuit 200 is connected to the drain of each gain control transistor M3 in K pixel units 100 in one column, for modulating the pixel full-well capacity of the floating diffusion nodes of the K pixel units 100, thereby providing a wider variety of conversion gains and enriching the low conversion gain modes; K is an integer greater than or equal to 2. Note that, in FIGS. 5-9, each pixel unit 100 is shown to have only one photosensitive element 101, for the sake of simplicity.

As an example, the image sensor 10 includes K rows of pixel units 100, in which case, there is one gain control circuit 200 for each column of pixel units 100. As another example, the image sensor 10 includes more than K rows of pixel units 100, in which case, each K rows of pixel units 100 in the same column constitutes a first pixel group, and each first pixel group corresponds to one gain control circuit 200 respectively; that is, there are several gain control circuits 200 for each column of pixel units 100 (when there are at least 2K rows of pixel units in the image sensor).

For each column of pixel units 100, regardless of whether the number of gain control circuits 200 is one or more, the principle of regulating the pixel full-well capacity of the floating diffusion node of the corresponding pixel unit stays the same, except that the gain control circuits 200 can provide a wider variety of conversion gains when each is shared by a plurality of pixel units 100, but in this case the corresponding control will also be more complicated. In fact, an image sensor will generally include many rows and columns of pixel units, and to strike a balance between the conversion gains and control complexity, each column usually includes a plurality of first pixel groups, and the first pixel groups may each include different numbers of pixel units, such as 2, 3, 4, and so on.

Of the K pixel units of a certain column sharing one gain control circuit 200, each pixel unit has (Z+1) different conversion gain modes, i.e., one HCG mode and Z LCG modes, wherein Z is an integer greater than or equal to K. Note that the value of Z is determined jointly by the value of K and the circuit structure of the corresponding gain control circuit 200; specifically, Z=K when the gain control circuit 200 includes (K−1) segments of connecting lines, and Z>K when the gain control circuit 200 also includes switching transistors.

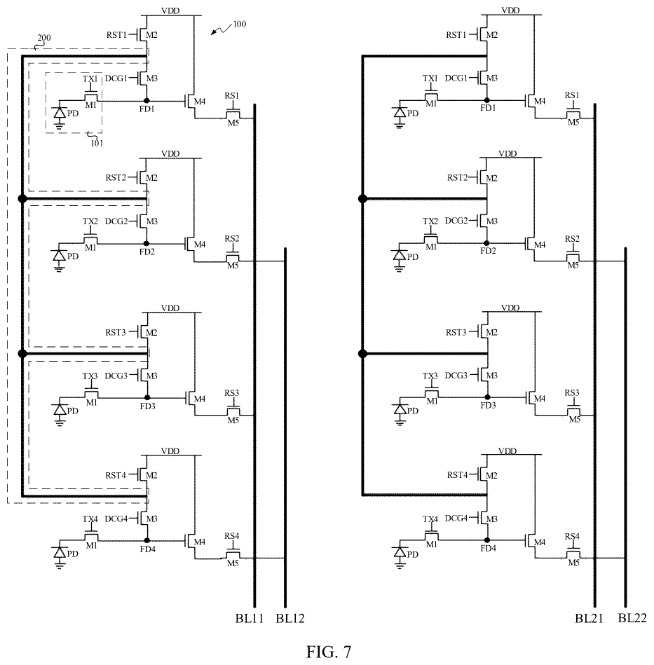

As an example, as shown in FIGS. 5 and 7, each of the gain control circuits 200 includes (K−1) segments of connecting lines, and the (K−1) segments of connecting lines connect the drains of the gain control transistors M3 of the K pixel units 100. Take FIG. 5 for example, each gain control circuit 200 includes one connecting line, connecting the drains of the gain control transistors M3 of two pixel units 100.

Of the K pixel units of a certain column sharing one gain control circuit 200, one connecting line is provided between the drains of the gain control transistors M3 of two pixel units 100 in adjacent rows to form a capacitance, and since the connecting line is located at a high-resistance node, a capacitance that satisfies a certain gain-conversion switching demand can be obtained by adjusting the line width of the connecting line to reduce the characteristic impedance, or by adjusting capacitances of the components. It is to be understood that the shape of each connecting line is not limited those depicted in the figures, as long as it can connect gain control transistors M3 of adjacent pixel units 100 when these gain control transistors M3 are turned on.

Assume that the capacitance value of the floating diffusion node of each pixel unit 100 in the K pixel units is respectively Cfd1, . . . , Cfdk, and the capacitance value of the (K−1) segments of connecting lines is Ca.

When the gain control transistors M3 in the K pixel units 100 are all turned off, the gain capacitance value of a first pixel unit 100 among the K pixel units 100 is the capacitance value of the floating diffusion node of the first pixel unit 100 itself, i.e., Cfd1, and the conversion gain thereof is q/Cfd1, q being the amount of charges generated in the first pixel unit when the photoelectric effect occurs, and at this time, the conversion gain is the highest, and therefore the first pixel unit is in the HCG mode.

When the gain control transistor M3 in the first pixel unit 100 is turned on and the gain control transistors M3 in the remaining (K−1) pixel units 100 are turned off, the gain capacitance value of the first pixel unit 100 is the sum of the capacitance value of the floating diffusion node of the first pixel unit 100 and the capacitance value of the (K−1) segments of connecting lines, i.e., Cfd1+Ca. Therefore, the conversion gain thereof is q/(Cfd1+Ca), which is smaller compared to the conversion gain in HCG mode, so this case can be defined as the LCG1 mode to provide a lower conversion gain in relatively bright environments, but the LCG1 mode has the highest conversion gain among all the LCG modes.

When the gain control transistors M3 in the first and second pixel units 100 of the K pixel units 100 are turned on, and the gain control transistors M3 in the remaining pixel units 100 are turned off, the gain capacitance value of the first pixel unit 100 is the sum of the capacitance value of the floating diffusion node itself of the first and second pixel units 100 and the capacitance value of the (K−1) segments of connecting lines, i.e., Cfd1+Ca+Cfd2, and the conversion gain thereof is q/(Cfd1+Ca+Cfd2) , and since there are and there are only two adjacent pixel units 100 whose drains of gain control transistors M3 are connected to each other through the corresponding connecting lines, the conversion gain at this time is lower than that of the LCG1 mode, and this case can be defined as the LCG2 mode.

For the case where K=2, the LCG2 mode is the mode with the lowest conversion gain among all the LCG modes. For the case where K is greater than 2, a lower conversion gain may be obtained by further turning on the gain control transistor M3 of a next pixel unit 100 on the basis of the LCG2 mode, or other lower LCG modes. For example, a third low conversion gain (LCG3) mode is one in which the gain control transistors M3 in the first, second, and third pixel units 100 of the K pixel units 100 are turned on and the gain control transistors M3 in the remaining pixel units 100 are turned off, at which time the gain capacitance value of the first pixel unit 100 is the sum of the capacitance value of the floating diffusion nodes of the first three pixel units 100 and the capacitance value of the (K−1) segments of connecting lines, i.e. Cfd1 +Ca+Cfd2+Cfd3, which has a conversion gain of q/(Cfd1+Ca+Cfd2+Cfd3), lower than that of the LCG2 mode.

So on and so forth, until the gain control transistors M3 in the K pixel units 100 are all turned on, the K pixel units 100 will share the capacitance of each other's floating diffusion nodes, at which time the gain capacitance value of the first pixel unit 100 is the sum of the capacitance value of the floating diffusion nodes of the K pixel units 100 and the capacitance value of the (K−1) segments of connecting lines, i.e., Cfd1+Ca+Cfd2+ . . . +Cfdk, which has a conversion gain of q/(Cfd1+Ca+Cfd2+ . . . +Cfdk), which may be defined as a Zth low conversion gain (LCGz) mode, and the LCGz mode is the mode with the lowest conversion gain among all the LCG modes.

Note that as the number of gain control transistors M3 included increases, the gain capacitance value of the corresponding pixel unit 100 also increases, thereby further increasing the gain capacitance value, leading to a lower conversion gain. By providing more LCG modes, more detailed images can be output for different high light environments.

Based on the same principle, the other pixel units 100 (other than the first pixel unit) in the K pixel units 100 sharing one gain control circuit can also provide more low-conversion gain modes, and by controlling the on and off of the gain control transistor M3 in each of the K pixel units 100, the gain capacitance values of the K pixel units 100 can be individually controlled, so as to make the pixel full-well capacity of the image sensor 10 more controllable. Thus the image sensor 10 of the present disclosure is capable of providing more gain modes, and therefore is applicable in a wider ranges of scenarios.

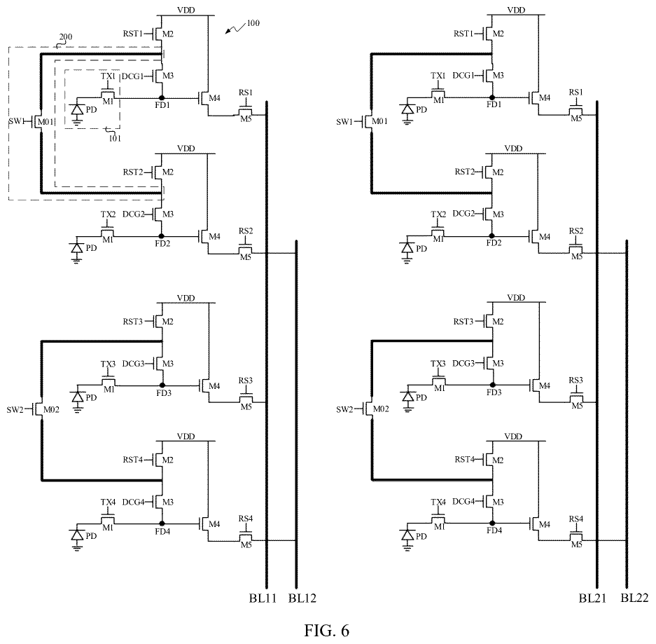

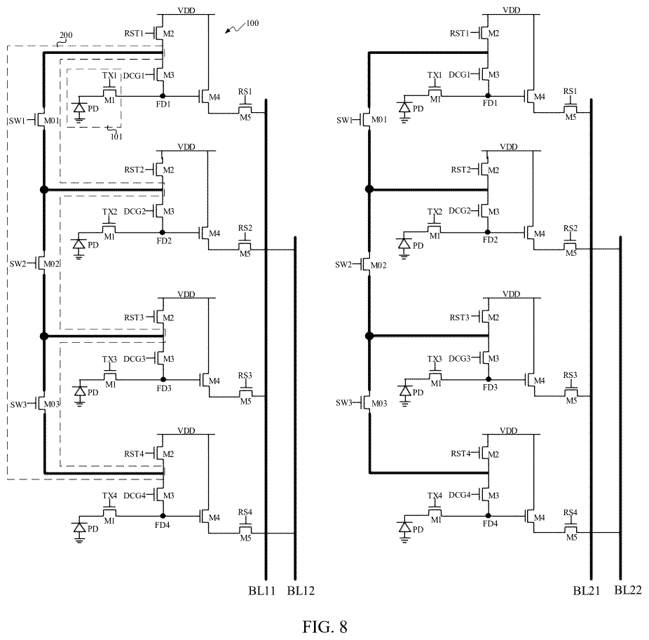

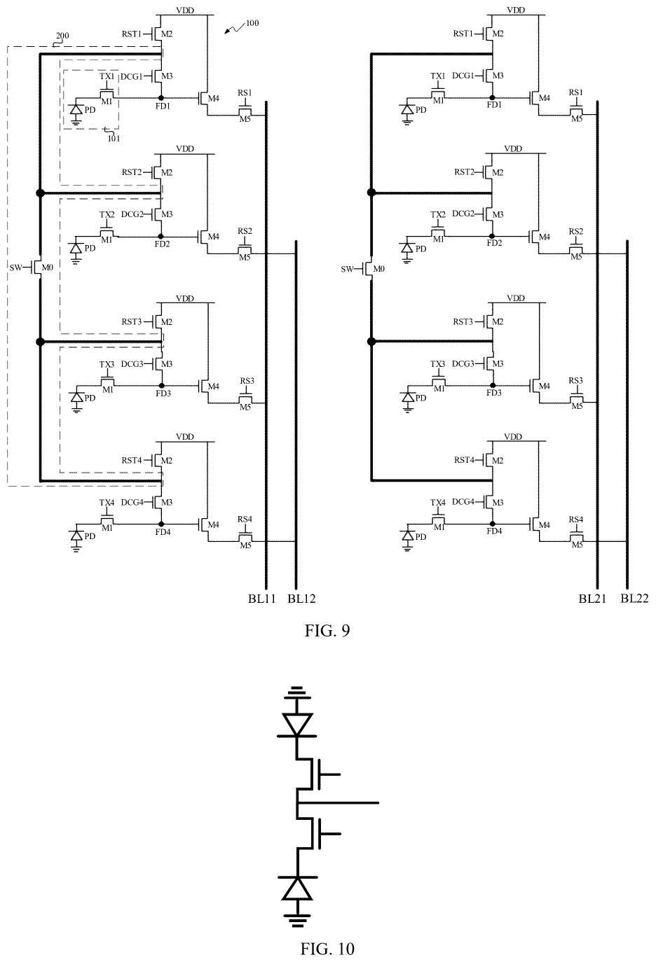

As another example, as shown in FIG. 6, FIG. 8, and FIG. 9, one or more switching transistors are provided on at least one segment of the (K−1) segments of connecting lines. Each switching transistor separates a corresponding segment of connecting line into at least two segments of connecting sublines when the switching transistor is turned off under control of a switching control signal, because the connecting lines themselves have certain capacitance, in some examples, device capacitance is provided on the connecting lines, each segment of connecting subline can provide a new conversion gain, thereby expanding the pixel full-well capacity of the pixel units 100 and the available range of gain modes. Note that each additional switching transistor adds at least one new conversion gain and at least one corresponding gain mode to the image sensor 10.

As an example, as shown in FIGS. 6 and 8, one or more switching transistors are provided on each of the (K−1) segments of connecting lines. The number of switching transistors on each segment of connecting line may be one or more. At the same time, the numbers of switching transistors on different segments of connecting lines may be the same or different, so that the pixel units 100 in the image sensor 10 can have more adjustable gain capacitance values, which in turn renders the output of the image sensor 10 more delicate in high light environments. Preferably, there is only one switching transistor on each segment of connecting line.

In FIG. 8, K=4, i.e., each gain control circuit 200 includes three segments of connecting lines and three switching transistors are disposed on the three segments of connecting lines, respectively, and the three segments of connecting lines are connected to the drains of the gain control transistors M3 in the first to fourth pixel units 100 in the corresponding column; the capacitance values of the floating diffusion nodes of the first to fourth pixel units 100 are Cfd1, Cfd2, Cfd3, and Cfd4, respectively, and the three segments of connecting lines are divided into six segments of connecting sublines (i.e., first, second, . . . , sixth connecting sublines) by the switching transistors M01, M02, and M03, and the capacitance values of the six segments of connecting sublines are Cb, Cc, Cd, Ce, Cf, and Cg, respectively, and Ca=Cb+Cc+Cd+Ce+Cf+Cg; for example, Cb and Cc correspond to the first and second connecting sublines which are parts of the first segment of connecting line.

When the gain control transistors M3 in the first to fourth pixel units 100 are all turned off, the gain capacitance value of the first pixel unit 100 is the capacitance value of the floating diffusion node of the first pixel unit 100 itself, i.e., Cfd1, and the conversion gain thereof is q/Cfd1, and at this time, the image sensor 10 is operated in the HCG mode.

When the gain control transistor M3 in the first pixel unit 100 is turned on and the switching transistor M01 on the first segment of connecting line (i.e., the segment connecting the drains of the gain control transistors M3 in the first and second pixel units 100) is turned off, the gain capacitance value of the first pixel unit 100 is the sum of the capacitance value of the floating diffusion node of the first pixel unit 100 itself and the capacitance value of the first connecting subline (i.e., part of the first segment of connecting line), i.e., Cfd1+Cb, and the conversion gain thereof is q/(Cfd1+Cb), which is lower than the conversion gain in the HCG mode, and can be defined as an LCG1 mode, and the LCG1 mode is the mode with the highest conversion gain among all LCG modes.

When the gain control transistor M3 in the first pixel unit 100 is turned on, the switching transistor M01 on the first segment of connecting line is turned on, and the gain control transistor M3 in the second pixel unit 100 and the switching transistor M02 on the second segment of connecting line are turned off, the gain capacitance value of the first pixel unit 100 is the sum of the capacitance value of the floating diffusion node of the first pixel unit 100 itself, the capacitance value of the first segment of connecting line, and the capacitance value of the third connecting subline, i.e., Cfd1+Cb+Cc+Cd, and the conversion gain thereof is q/(Cfd1+Cb+Cc+Cd), which is lower than the conversion gain in the LCG1 mode, and can be defined as an LCG2 mode.

When the gain control transistor M3 in the first pixel unit 100 is turned on, the switching transistor M01 on the first segment of connecting line is turned on, the switching transistor M02 on the second segment of connecting line is turned on, the gain control transistors M3 in the second and third pixel units 100 are turned off, and the switching transistor M03 on the third segment of connecting line is turned off, the gain capacitance value of the first pixel unit 100 is the sum of the capacitance value of the floating diffusion node of the first pixel unit 100, the capacitance value of the first segment of connecting line, the capacitance value of the second segment of connecting line, and the capacitance value of the fifth connecting subline, i.e., Cfd1+Cb+Cc+Cd+Ce+Cf, and the conversion gain thereof is q/(Cfd1+Cb+Cc+Cd+Ce+Cf), which is lower than the conversion gain in the LCG2 mode, and can be defined as an LCG3 mode.

So on and so forth, the gain capacitance value of the first pixel unit 100 can be regulated by turning on or off gain control transistors M3 in certain pixel units 100 and/or switching transistors on certain segments of connecting lines, thereby generating more LCG modes.

When all of the gain control transistors M3 in the four pixel units 100 are turned on and all of the three switching transistors on the three segments of connecting lines are turned on, the gain capacitance value of the first pixel unit 100 is the sum of the capacitance value of the floating diffusion nodes of the four pixel units 100 and the capacitance value of the three segments of connecting lines, i.e., Cfd1+Cfd2+Cfd3+Cfd4+Ca, and the conversion gain thereof is q/(Cfd1+Cfd2+Cfd3+Cfd4+Ca), which can be defined as an LCGz mode, which is the mode with the lowest conversion gain among all LCG modes.

In one example, some of the (K−1) segments of connecting lines do not have any switching transistor thereon; similarly, the number of switching transistors, if any, on each segment of connecting line may be one or more. Preferably, when K is an even number, in each column, the one or more switching transistors are only provided on the connecting line between the (K/2)th pixel unit 100 and the (K/2+1)th pixel unit 100; this arrangement maximize the area of each pixel array including a number of pixel units 100 while increasing the conversion gain of the image sensor 10, mitigating the actual scale loss of the pixel array due to extra switching transistors in the gain control circuit, thereby enhancing the optical efficiency of the image sensor 10.

In FIG. 9, K=4, each gain control circuit 200 includes three segments of connecting lines, and one switching transistor disposed on the second segment of connecting line between the second pixel unit 100 and the third pixel unit 100 of the four pixel units sharing this gain control circuit, assuming that the capacitance values of the floating diffusion nodes of the four pixel units 100 are Cfd1, Cfd2, Cfd3, and Cfd4, respectively, and that the capacitance value of the first segment of connecting line is (Cb+Cc), the second segment of connecting line is separated by the switching transistor into two connecting sublines corresponding to capacitance values Cd and Ce, respectively, and the capacitance value of the third segment of connecting line is (Cf+Cg), wherein Ca=Cb+Cc+Cd+Ce+Cf+Cg.

In each column, when the gain control transistors M3 in the first to fourth pixel units 100 are all turned off, the gain capacitance value of the first pixel unit 100 is the capacitance value of the floating diffusion node of the first pixel unit 100 itself, i.e., Cfd1, and the conversion gain thereof is q/Cfd1, and at this time, the image sensor 10 is operated in the HCG mode.

When the gain control transistor M3 in the first pixel unit 100 is turned on, the switching transistor M0 is turned off, and the gain control transistor M3 in the second row of pixel units 100 is turned off, the gain capacitance value of the first pixel unit 100 is the sum of the capacitance value of the floating diffusion node of the first pixel unit 100 itself, the capacitance value of the first segment of connecting line, and the capacitance value of the third connecting subline (part of the second segment of connecting line), i.e., Cfd1+Cb+Cc+Cd, the conversion gain thereof is q/(Cfd1+Cb+Cc+Cd), which is lower than that in the HCG mode, and can be defined as a LCG1 mode, which is the mode with the highest conversion gain among all LCG modes.

When the gain control transistor M3 in the first pixel unit 100 is turned on, the switching transistor M0 is turned on, and the gain control transistors M3 in the second to fourth pixel units are turned off, the gain capacitance value of the first pixel unit 100 is the sum of the capacitance value of the floating diffusion node of the first pixel unit 100 itself, the capacitance value of the first segment of connecting line, the capacitance value of the second segment of connecting line, and the capacitance value of the third segment of connecting line, i.e., Cfd1+Ca, and the conversion gain thereof is q/(Cfd1+Ca), which is lower than that in the LCG1 mode, and can be defined as a LCG2 mode.

When the gain control transistors M3 in the first and second pixel units 100 are turned on and the switching transistor M0 is turned off, the gain capacitance value of the first pixel unit 100 is the sum of the capacitance values of the floating diffusion nodes of the first and second pixel units 100, the capacitance value of the first segment of connecting line, and the capacitance value of the third connecting subline (part of the second segment of connecting line), i.e., Cfd1+Cb+Cc+Cfd2+Cd, and the conversion gain thereof is q/(Cfd1+Cb+Cc+Cfd2+Cd), which is lower than that in the LCG2 mode, and can be defined as a LCG3 mode.

When the gain control transistors M3 in the first and second pixel units 100 are turned on, the gain control transistors M3 in the third and fourth pixel units 100 are turned off, and the switching transistor M0 is turned on, the gain capacitance value of the first pixel unit 100 is the capacitance value of the floating diffusion node of the first and second pixel units 100, the capacitance value of the first segment of connecting line, the capacitance value of the second segment of connecting line, and the capacitance value of the third segment of connecting line, i.e., Cfd1+Cfd2+Ca, and the conversion gain thereof is q/(Cfd1+Cfd2+Ca), which is lower than that in the LCG3 mode, and can be defined as a LCG4 mode.

When the gain control transistors M3 in the first to third pixel units 100 are turned on, the gain control transistor M3 in the fourth pixel unit 100 is turned off, and the switching transistor M0 is turned on, the gain capacitance value of the first pixel unit 100 is the sum of the capacitance values of the floating diffusion nodes of the first to third pixel units 100, the capacitance value of the first segment of connecting line, the capacitance value of the second segment of connecting line, and the capacitance value of the third segment of connecting line, i.e., Cfd1+Cfd2+Cfd3+Ca, and the conversion gain thereof is q/(Cfd1+Cfd2+Cfd3+Ca), which is lower than that in the LCG4 mode, and can be defined as a LCG5 mode.

When the gain control transistors M3 in the four pixel units 100 are all turned on and the switching transistor M0 is turned on, the gain capacitance value of the first pixel unit 100 is the sum of the capacitance values of the floating diffusion nodes in the four pixel units 100, the capacitance value of the first segment of connecting line, the capacitance value of the second segment of connecting line, and the capacitance value of the third segment of connecting line, i.e., Cfd1+Cfd2+Cfd3+Cfd4+Ca, and the conversion gain thereof is q/(Cfd1+Cfd2+Cfd3+Cfd4+Ca), which is lower than that in the LCG5 mode, and can be defined as a LCG6 mode, which is the mode with the lowest conversion gain (i.e., Z=6) among all the LCG modes.

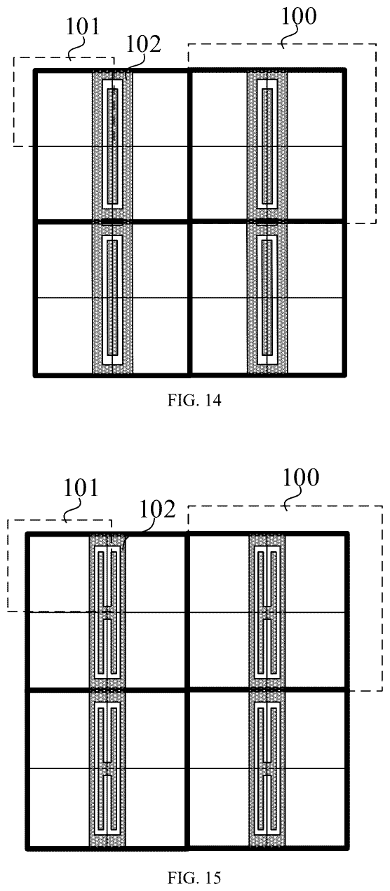

Specifically, in a direction perpendicular to the plane containing the pixel arrays, the orthographic projection 102 of connecting lines and the orthographic projection of photosensitive units 101 are overlapped, and the overlapping ratio is not greater than 50%. As shown in FIG. 13, as an example, four photosensitive units 101 arranged in a 2×2 array constitute a pixel unit 100, the shaded areas in FIG. 13 are the projection of the connecting lines onto the pixel unit 100s; for each photosensitive unit 101 to have a sufficiently large effective photosensitive area, it is necessary to ensure that, in a direction perpendicular to the pixel units 100 (i.e., a direction perpendicular to the CNBC plane of the “paper” on which FIG. 13 is drawn), the overlapping area between the orthographic projection 102 of the connecting lines and the orthographic projection of each photosensitive unit 101 does not account for more than 50% of the area of a single photosensitive unit 101. That is, less than 50% of the area of each photosensitive unit 101 is obstructed by connecting lines. The connecting lines may be wired in various ways, as shown in FIGS. 14 to 16.

Note that, in the above examples, the high and low conversion gain modes are all ordered assuming that the capacitance value Ca of the (K−1) segments of connecting lines is less than the capacitance value of each of the floating diffusion nodes, and a person skilled in the art should understand that the above assumption is merely exemplary. In practice, the capacitance value Ca may be greater than the capacitance value of one or more of the floating diffusion nodes, or even greater than all of the floating diffusion nodes, by means of line widths, line shapes, etc., of the (K−1) segments of connecting lines, in which case, the ordering of the various LCG modes should be adjusted accordingly.

The present disclosure introduces a wider ranges of low-conversion gains by having gain control circuits 200 in the image sensor 10, with each of the gain control circuits 200 connected to the drains of the gain control transistors M3 of K pixel units 100 in the same column; by controlling the amount of capacitance connected to the gain control transistor in each pixel unit of the image sensor in a LCG mode, the corresponding conversion gains are adjusted, thereby improving the dynamic range of the image sensor 10, and allowing it to output images that are more detailed in high light environments.

In the image sensor 10 of the present disclosure, when signal output is performed via bit lines, as shown in FIGS. 3, 17, and 19, of the pixel units 100 located in the same column, each X pixel units 100 (adjacent or not) share one bit line, and X*Y adjacent pixel units 100 in the same column are read out via Y bit lines, wherein X is an integer greater than or equal to 1, and Y is an integer greater than or equal to 2. Setting up the bit lines in this manner allows for faster and more efficient readout, and since there is no need to sample and hold the output of the pixel circuit, the KT/C noise of the circuit can be reduced, the noise level of the circuit will be lower, and the image sensor's performance can be further improved.

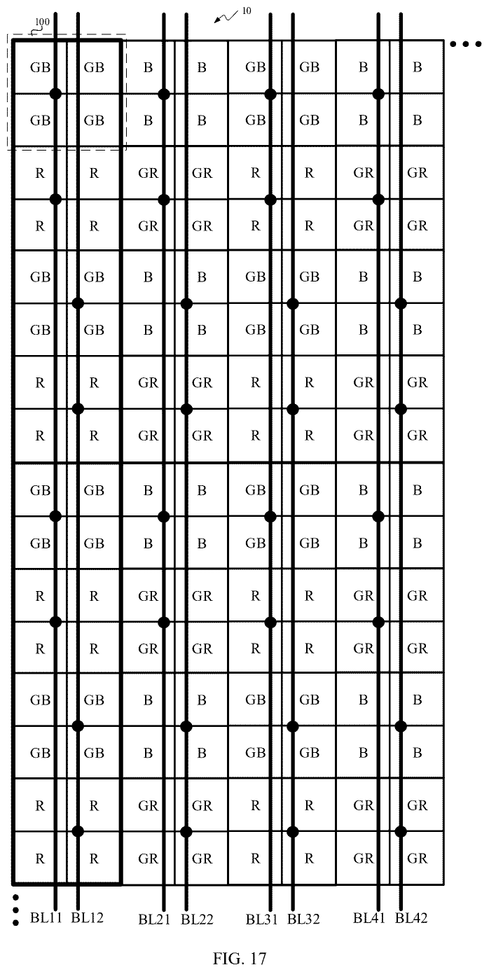

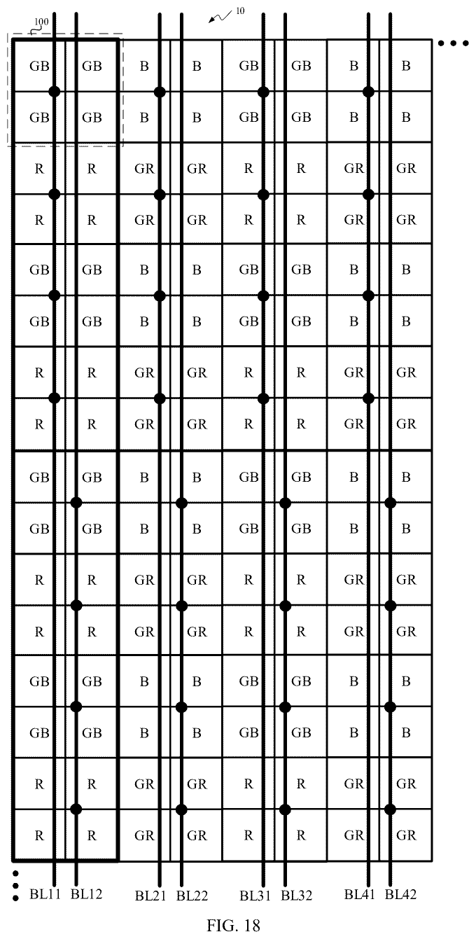

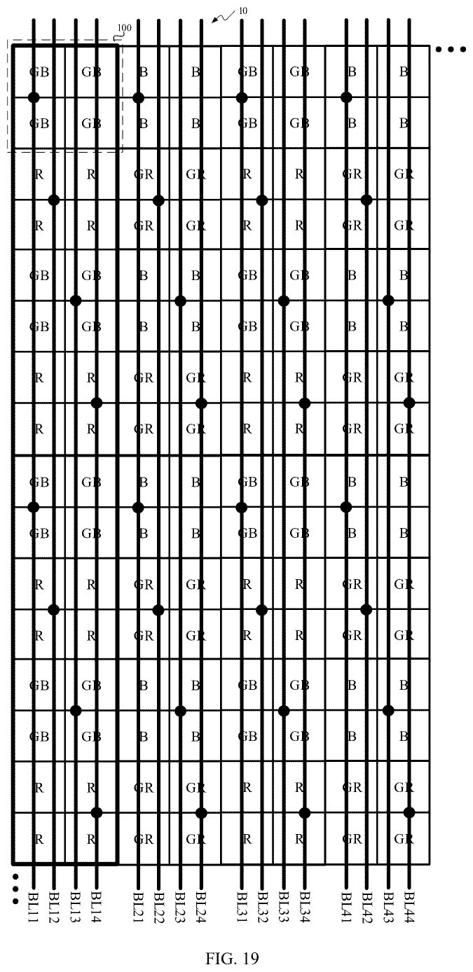

As an example, the number of pixel units 100 in each column is X*Y, in which case every X pixel units from the top to the bottom share one bit line and for each column a total of Y bit lines are used to read out the X*Y pixel units 100. As another example, the number of pixel units 100 in each column is greater than X*Y (for example, n*X*Y, n being an integer greater than 1) , in which case, in each column, each X*Y pixel units constitutes a second pixel group, and pixel units in each second pixel group are connected to the same bit line. FIG. 3 illustrates how pixels units in different second pixel groups are connected to bit-lines when X=1 and Y=2. FIG. 17 illustrates how pixels units in different second pixel groups are connected to bit-lines when X=2 and Y=2. FIG. 18 illustrates how pixels units in different second pixel groups are connected to bit-lines when is X=4 and Y=2. FIG. 19 illustrates how pixels units in different second pixel groups are connected to bit-lines when X=1 and Y=4.

In practice, the values of X and Y should be determined according to practical requirements; for example, X may be 1, 2, 4, etc., and Y may be 2, 4, 8, etc.

In addition, in the process of reading out the image signal, it is necessary to perform a combined readout (binning) of the pixel units receiving the same color light, so that the resolution of the samples can be reduced and the frame rate can be increased when the channel bandwidth stays unchanged; binning includes horizontal binning and vertical binning. Horizontal binning involves adding the charges of neighboring rows together before readout; vertical binning involves adding the charges of adjacent columns together before readout.

The present disclosure takes the horizontal binning as an example, where the number of bit lines used for each column is positively correlated with the data bit width (unit: bit) of the image signal readout of the image sensor: when the data bit width for image signal readout is Y bit, Y bit lines are used for each column, and pixel units connected to each of the bit lines receive light of the same color, and the pixel units connected to the same bit lines are equidistant (i.e., they are evenly spaced apart by a fixed number of rows). For example, in FIG. 3, the data bit width is 2 bit, 2 bit lines are used for each column, the pixel units connected to each bit line receive light of the same color, and the pixel units connected to the same bit line are spaced apart from each other by one row. In FIG. 19, the data bit width is 4 bit, 4 bit lines are used for each column, the pixel units connected to each bit line receive light of the same color, and the pixel units connected to the same bit line are spaced apart from each other by three rows; by connecting pixel units receiving light of the same color to the same bit line, a faster speed of pixel merging can be obtained; note that since the bit lines increase the actual area of the quantization circuit and occupy the layout area of the image sensor, preferably Y≤4, i.e., the data bit width for image signal readout is 4 bits, and 4 bit lines are used for each column.

### Embodiment 2

Embodiment 2 provides a reading method based on the image sensor 10 disclosed in Embodiment 1, including: reading image signals of K rows of pixel units 100, row by row. Specifically, when reading is on the image sensor 10 disclosed in Embodiment 1, image signals of the pixel units 100 in the image sensor 10 are read row by row starting from a first row. The image signals include reset signals and pixel signals.

As shown in FIGS. 5-9 , of the K rows of pixel units, each row of pixel units has (Z+1) different conversion gain modes, i.e., one high HCG mode and Z LCG modes, wherein Z≥K. Note that the value of Z is determined jointly by the value of K and the circuit structure of the corresponding gain control circuit 200; specifically, Z=K when the gain control circuit 200 includes (K−1) segments of connecting lines, and Z>K when the gain control circuit 200 also includes switching transistors. In the following, the present disclosure exemplarily illustrates the read control for different conversion gain modes using any row of the K rows of pixel units (e.g., the first row) as the selected row.

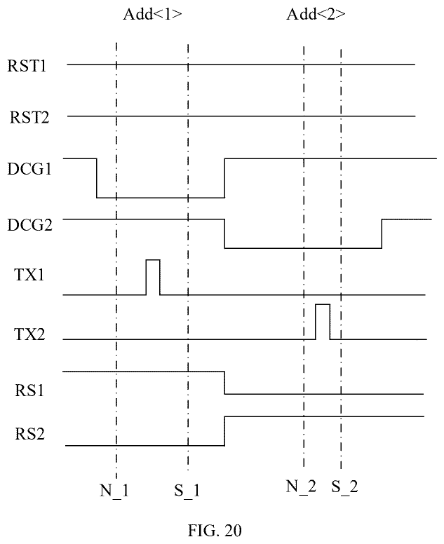

As shown in FIG. 20, reading the image signals of the pixel units 100 in the first row (hereinafter, first-row pixel units) in the HCG mode are as follows: turning on the reset transistor M2 and the gain control transistor M3 in each first-row pixel unit 100, and perform a reset operation on the floating diffusion node FD1 in each first-row pixel unit 100; turning off the gain control transistor M3 in each first-row pixel unit 100 and reading the reset signal of each first-row pixel unit 100 (e.g., N_1 moment). turning on the transmission transistor M1 in each first-row pixel unit 100, performing charge transfer and reading the pixel signal of each first-row pixel unit 100 in the HCG mode (e.g., S_1 moment).

Specifically, regardless of different potential circuit structures of different gain control circuits 200 (where each gain control circuit includes K−1 segments of connecting lines, as shown in FIGS. 5 and 7, or where each gain circuit further includes switching transistor as shown in FIGS. 6, 8, and 9), the reading of the reset signals, the charge transfer, and the reading of the pixel signals are performed when the gain control transistor M3 in each first-row pixel unit 100 is turned off, at which time the gain capacitance value of each first-row pixel unit 100 is the capacitance value of the floating diffusion node of the respective first-row pixel unit 100, i.e., Cfd1, and the conversion gain thereof is q/Cfd1.

The reset transistor M2 in each of the K rows of pixel units 100 stays turned on when the above-mentioned steps are being performed; in practice, the reset transistors M2 in each row of pixel units 100 may also be turned off after the reset operation is performed on them. However, since the gain control transistors M3 in each row of pixel units 100 are turned off when their reset signals and pixel signals are read, the signal reading of the selected row of pixel units 100 will not be affected even if the reset transistors M2 in the corresponding row of pixel units 100 remain turned on for a long time.

When the gain control transistors M3 in the selected row of pixel units are turned off, the gain control transistors M3 in unselected rows of pixel units 100 are turned on. In practice, the gain control transistors M3 in each row of pixel units are turned off only when reading the reset signals, or when transferring charges and reading the pixel signals, and they are turned on at other times. When the gain control transistors M3 in the selected row of pixel units 100 are turned off, the gain control transistors M3 in the unselected rows of pixel units 100 may also be turned off, which has no effect on the reading of signals in the selected row.

Each pixel unit 100 also includes a select transistor M5, which is used to select the row of pixel units whose reset signals and pixel signals are to be read out. When reading the reset signals and pixel signals, the select transistors M5 in the selected row of pixel units 100 are turned on, and the select transistors M5 in the unselected rows of pixel units 100 are turned off, completing reading the reset signals and pixel signals of the selected row.

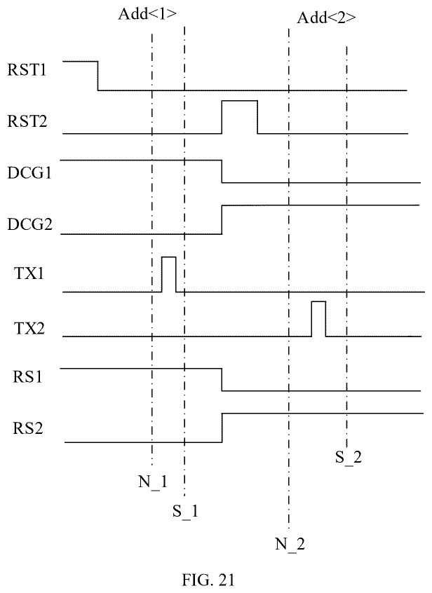

Take the LCG1 mode as an example, wherein the LCG1 mode is the mode with the highest conversion gain among all LCG modes; as shown in FIG. 21, reading the image signals of the first-row pixel units 100 in the LCG1 mode is as follows: turning on the reset transistors M2 and the gain control transistors M3 in the first-row pixel units 100, turning off the gain control transistors M3 in the pixel units 100 in rows other than the first row, and performing reset operations on the floating diffusion nodes in the first-row pixel units 100; turning off the reset transistors M2 in the first-row pixel units 100, and reading the reset signals of the first-row pixel units 100 (e.g., N_1 moment); turning on the transmission transistors M1 in the first-row pixel units 100, performing charge transfer and reading the image signals of the first-row pixel units 100 in the LCG1 mode (e.g., S_1 moment).

Specifically, for the case where each gain control circuit 200 includes (K−1) segments of connecting lines, as shown in FIGS. 5 and 7, the reset transistor M2 and the gain control transistor M3 in each first-row pixel unit are turned on, and the gain control transistors M3 in the pixel units 100 in the rows other than the first row are turned off, at which time, the value of gain capacitance of each first-row pixel unit 100 is Cfd1+Ca and the conversion gain thereof is q/(Cfd1+Ca), which is less than its conversion gain in the HCG mode, and is the highest conversion gain in all LCG modes.

For the case where each gain control circuit 200 also includes switching transistors, as shown in FIGS. 6, 8, and 9, before performing reset operations on the floating diffusion nodes in the selected row of pixel units 100, when turning on the reset transistors M2 and the gain control transistors M3 in the first row of pixel units 100 and turning off the gain control transistors M3 in the pixel units 100 in the rows other than the first row, it is also required that all the switching transistors are turned off, at which time the gain capacitance value of each first-row pixel unit 100 is Cfd1+Cb, and the conversion gain thereof is q/(Cfd1+Cb), which is less than its conversion gain in the HCG mode, and is the highest conversion gain in all LCG modes.

Each pixel unit 100 also includes a select transistor M5, which is used to select the row of pixel units whose reset signals and pixel signals are to be read out. When reading the reset signals and image signals, the select transistors M5 in the selected row of pixel units 100 are turned on, and the select transistors M5 in the unselected rows of pixel units 100 are turned off, completing reading the reset signals and pixel signals of the selected row.

Taking the LCG2 mode as an example, for the case where each gain control circuit 200 includes (K−1) segments of connecting lines (as shown in FIGS. 5 and 7), reading the image signals of the first-row pixel units 100 in the LCG2 mode includes: turning on the reset transistors M2 and the gain control transistors M3 in the first-row pixel units 100, turning on the gain control transistors M3 in the pixel units 100 in the second row (hereinafter, second-row pixel units), turning off the gain control transistors M3 in the pixel units 100 in rows other than the first row and the second row, and performing reset operations on the floating diffusion nodes in the first-row pixel units 100; turning off the reset transistors M2 in the first-row pixel units 100, and reading the reset signals of the first-row pixel units 100; turning on the transmission transistors M1 in the first-row pixel units 100, performing charge transfer and reading the image signals of the first-row pixel units 100 in the LCG2 mode. The gain capacitance value of each first-row pixel unit 100 is Cfd1+Ca+Cfd2, and the conversion gain thereof is q/(Cfd1+Ca+Cfd2), which is less than its conversion gain in the corresponding LCG1 mode.

Similarly, the third to the (Z−1)th LCG modes are realized by turning on increasingly more gain control transistors M3 in the unselected rows of pixel units 100; for example, in the LCG3 mode, the gain control transistors M3 in the pixel units 100 in the first to third rows are turned on, and the gain control transistors M3 in the pixel units 100 in the other rows are turned off; in the LCG4 mode, the gain control transistors M3 in the pixel units 100 in the first to fourth rows are turned on and the gain control transistors M3 in the pixel units 100 in the other rows are turned off, so on and so forth; accordingly, the conversion gains of the first to the (Z−1)th LCG modes gradually decrease.

For the case where each gain control circuit 200 also includes one or more switching transistors (as shown in FIGS. 6, 8, and 9), reading the image signals of the first-row pixel units 100 in the LCG2 mode includes: turning on the reset transistors M2 and the gain control transistors M3 in the first-row pixel units 100, turning off the gain control transistors M3 in the pixel units 100 in the rows other than the first row, turning on the first switching transistor of each gain control circuit 200, turning off the switching transistors of each gain control circuit 200 other than the first switching transistor, and performing reset operations on the floating diffusion nodes in the first-row pixel units 100; turning off the reset transistors M2 in the first-row pixel units 100, and reading the reset signals of the first-row pixel units 100; turning on the transmission transistors M1 in the first-row pixel units 100, performing charge transfer and reading the image signals of the first-row pixel units 100 in the LCG2 mode. For the structures illustrated in FIGS. 6 and 9, the gain capacitance value of each first-row pixel unit 100 is Cfd1+Ca, and the conversion gain thereof is q/(Cfd1+Ca), which is less than the conversion gain in the LCG1 mode. For the structure illustrated in FIG. 8, the gain capacitance value of each first-row pixel unit 100 is Cfd1+Cb+Cc+Cd, and the conversion gain thereof is q/(Cfd1+Cb+Cc+Cd), which is less than the conversion gain in the LCG1 mode.

Similarly, the third to the (Z−1)th LCG modes are realized by turning on increasingly more gain control transistors M3 in the unselected rows of pixel units 100, and/or turning on increasingly more switching transistors of the gain control circuits; accordingly, the conversion gains of the first to the (Z−1)th LCG modes gradually decrease.

For the second to the (Z−1)th LCG modes, when reading the reset signals and image signals of the selected row of pixel units 100, the select transistors M5 in the selected row of pixel units 100 are turned on, and the select transistors M5 in the unselected rows of pixel units 100 are turned off, completing reading the reset signals and pixel signals of the selected row. Optionally, it is also practical to turn on all the select transistors M5 in rows whose gain control transistors M3 are turned on, to read the reset signals and pixel signals of the first-row pixel units 100 by a multi-row simultaneous readout method, which can effectively improve the signal readout speed.

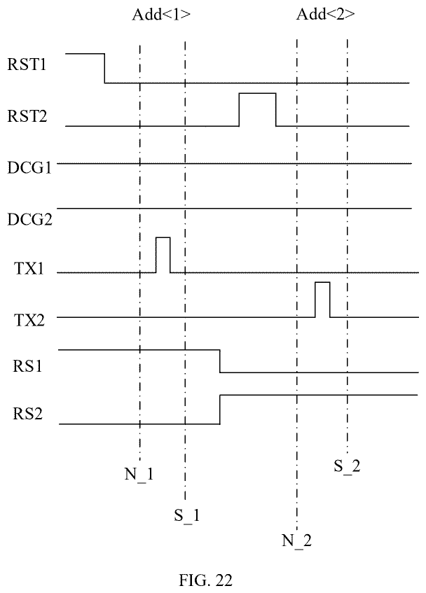

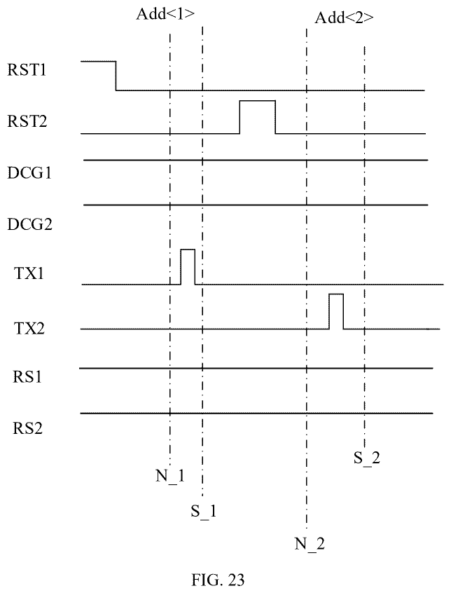

Take the LCGz mode as an example, wherein the LCGz mode is the mode with the lowest conversion gain among all LCG modes. As shown in FIGS. 22 and 23, in the LCGz mode, reading out the image signals of the first-row pixel units 100 includes: turning on the gain control transistors M3 in the K rows of pixel units 100 (for each column, including K pixel units sharing one gain control circuit), turning on the reset transistors M2 in the first-row pixel units 100, and performing reset operations on the floating diffusion nodes in the first-row pixel units 100; turning off the reset transistors M2 in the first-row pixel units 100, and reading the reset signals of the first-row pixel units 100 (e.g., N_1 moment); turning on the transmission transistor M1 in each first-row pixel unit 100, performing charge transfer and reading the pixel signal of each first-row pixel unit 100 in the LCGz mode (e.g., S_1 moment).

Specifically, for the case where each gain control circuit 200 includes (K−1) segments of connecting lines, as shown in FIGS. 5 and 7, when the gain control transistors M3 in the K rows of pixel units 100 are turned on, the K pixel units 100 in each column will share each other's floating diffusion nodes. For the case where each gain control circuit 200 also includes one or more switching transistors, as shown in FIGS. 6, 8, and 9, when the gain control transistors M3 in the K rows of pixel units 100 are turned on before reset operations on the floating diffusion nodes in the selected row of pixel units, all the switching transistors are also turned on, at which time, the K pixel units in each column 100 will share each other's floating diffusion nodes; wherein the gain capacitance value of each first-row pixel unit 100 is Cfd1+Ca+Cfd2+ . . . +Cfdk, and the conversion gain thereof is q/(Cfd1+Ca+Cfd2+ . . . +Cfdk), which is the lowest conversion gain for all the LCG modes.

Each pixel unit 100 also includes a select transistor M5, which is used to select the row of pixel units whose reset signals and pixel signals are to be read out. As an example, when reading the reset signals and image signals of the selected row of pixel units 100, as shown in FIG. 22, the select transistors M5 in the selected row of pixel units 100 are turned on, and the select transistors M5 in the unselected rows of pixel units 100 are turned off, completing reading the reset signals and pixel signals of the selected row. As another example, when reading the reset signals and the image signals of the selected row of pixel units 100, as shown in FIG. 23, the select transistors M5 in the K rows of pixel units 100 remain turned on, and the selected row and the non-selected rows are read out together, to read the reset signals and the pixel signals of the first-row pixel units 100, which can effectively increase the signal readout speed.

It should be note that during dynamic optical imaging, such as when entering a high light environment from a low light environment, it is necessary to switch the conversion gain mode from a high conversion gain mode to a low conversion gain mode; also, when entering a low light environment from a high light environment, it is necessary to switch the conversion gain mode from a low conversion gain mode to a high conversion gain mode. No reset operation is performed during the switching between different conversion gain modes.

### Embodiment 3

Embodiment 3 provides an electronic device including the image sensor 10 described in Embodiment 1. In practice, the electronic device may include one or more of a security camera, an automotive electronic camera, a cellphone camera, a drone, a machine-vision device, and any existing video camera.

In summary, the presently disclosed image sensor, reading method thereof, and the electronic introduce a wider ranges of low-conversion gains by having gain control circuits in the image sensor, with each of the gain control circuits connected to the drains of the gain control transistors of K pixel units in the same column; by controlling the amount of capacitance connected to the gain control transistor in each pixel unit of the image sensor in a LCG mode, the corresponding conversion gains are adjusted, thereby improve the dynamic range of the image sensor, and allowing it to output images that are more detailed in high light environments. The image sensor of the present disclosure has a higher image signal readout efficiency, and its circuit has a lower noise level, which can further improve the performance of the image sensor.

The above-mentioned embodiments are merely illustrative of the principle and effects of the present disclosure instead of restricting the scope of the present disclosure. Any person skilled in the art may modify or change the above embodiments without violating the principle of the present disclosure. Therefore, all equivalent modifications or changes made by those who have common knowledge in the art without departing from the spirit and technical concept disclosed by the present disclosure shall be still covered by the claims of the present disclosure.

1. An image sensor, comprising pixel units arranged in an array and at least one gain control circuit, wherein:
each of the pixel units comprises at least one photosensitive unit, a floating diffusion node, a gain control transistor, a source follower transistor, and a reset transistor, wherein the photosensitive unit is connected to the floating diffusion node through a corresponding transmission transistor; wherein in each pixel unit, the reset transistor is connected to the gain control transistor, which is connected to the floating diffusion node, and the reset transistor and the gain control transistor are co-connected to a gate of the source follower transistor;
of the pixel units located in a same column, each X pixel units share one bit line, and X*Y adjacent pixel units in the same column are read out via Y bit lines, wherein X is an integer greater than or equal to 1, and Y is an integer greater than or equal to 2;
each gain control circuit is connected to a drain of each gain control transistor in K pixel units in the same column, wherein K is an integer greater than or equal to 2.

2. The image sensor according to claim 1, wherein each gain control circuit comprises (K−1) segments of connecting lines, and the (K−1) segments connect the drain of each gain control transistor in the K pixel units sharing this gain control circuit.

3. The image sensor according to claim 2, wherein at least one of the (K−1) segments of connecting lines is provided with one or more switching transistors.

4. The image sensor according to claim 3, wherein when K is an even number, in each column, of the (K−1) segments of connecting lines, only the one connecting a (K/2)th pixel unit and a (K/2+1)th pixel unit is provided with the one or more switching transistors.

5. The image sensor according to claim 3, wherein each of the (K−1) segments of connecting lines is provided with the one or more switching transistors.

6. The image sensor according to claim 2, wherein in a direction perpendicular to the pixel units, an orthographic projection of connecting lines and an orthographic projection of the photosensitive unit are overlapped, and an overlapping ratio thereof is not greater than 50%.

7. The image sensor according to claim 1, wherein each K pixel units in the same column constitutes a first pixel group, and each first pixel group corresponds to one of the at least one gain control circuit respectively.

8. The image sensor according to claim 1, wherein each X*Y pixel units in the same column constitutes a second pixel group, and pixel units in each second pixel group are connected to the same bit line.

9. The image sensor according to claim 1, wherein when each pixel unit comprises a plurality of photosensitive units, the plurality of photosensitive units of each pixel unit is configured to receive light of the same color, wherein each plurality of photosensitive units constitutes one shared pixel unit.

10. The image sensor according to claim 9, wherein each pixel unit comprises four photosensitive units, and the four photosensitive units of each pixel unit are arranged in a 2×2 array; wherein each photosensitive unit comprises a photosensitive element and a transmission transistor, and the photosensitive element is connected to the corresponding floating diffusion node via the transmission transistor.

11. The image sensor according to claim 1, wherein each pixel unit further comprises a select transistor connected to a source of the source follower transistor.

12. A method for reading an image sensor as claimed in claim 1, wherein image signals of K rows of pixel units are read row by row, wherein the image signals comprise reset signals and pixel signals.

13. The method for reading an image sensor according to claim 12, comprising:
turning on the reset transistor and the gain control transistor in each pixel unit of a selected row of pixel units, to perform a reset operation on the floating diffusion node in each pixel unit of the selected row; turning off the gain control transistor in each pixel unit in the selected row and reading a reset signal of each pixel unit in the selected row; and
turning on the transmission transistor in each pixel unit in the selected row, performing charge transfer and reading a pixel signal from each pixel unit in the selected row in a high conversion gain mode.

14. The method for reading an image sensor according to claim 13, wherein the reset transistor in each pixel unit in the K rows of pixel units stays turned on all the time; the gain control transistor in each pixel unit in rows other than the selected row is turned on when the gain control transistor in each pixel unit in the selected row is turned off; wherein each pixel unit further comprises a selector transistor, wherein when reading the reset signal and the pixel signal of each pixel unit in the selected row, the selector transistor in each pixel unit in the selected row is turned on and the selector transistor in each pixel unit in the rows other than the selected row is turned off.

15. The method for reading an image sensor according to claim 12, comprising:
turning on the reset transistor and the gain control transistor in each pixel unit in the selected row, turning off the gain control transistor in each pixel unit in rows other than the selected row, and performing a reset operation on the floating diffusion node in each pixel unit in the selected row; turning off the reset transistor in each pixel unit in the selected row and reading the reset signal of each pixel unit in the selected row; and
turning on the transfer transistor in each pixel unit in the selected row, performing charge transfer and reading the pixel signal of each pixel unit in the selected row in a first low conversion gain mode.

16. The method for reading an image sensor according to claim 15, wherein when each gain control circuit comprises one or more switching transistors, before performing a reset operation on the floating diffusion node in each pixel unit in the selected row, the method further comprises turning off all switching transistors.

17. The method for reading an image sensor according to claim 15, wherein each pixel unit further comprises a selector transistor, and when reading the reset signal and the pixel signal of each pixel unit in the selected row, the selector transistor in each pixel unit of the selected row is turned on and the selector transistor in each pixel unit in rows than the selected row is turned off.

18. The method for reading an image sensor according to claim 12, comprising:
turning on the gain control transistor in each pixel unit in the K rows of pixel units, turning on the reset transistor in each pixel unit in the selected row, and performing a reset operation on the floating diffusion node in each pixel unit in the selected row; turning off the reset transistor in each pixel unit in the selected row and reading the reset signal of each pixel unit in the selected row; and
turning on the transfer transistor in each pixel unit in the selected row, performing charge transfer and reading the pixel signal of each pixel unit in the selected row in a Zth low conversion gain mode, wherein Z is an integer greater than or equal to K; and/or
wherein when each gain control circuit comprises one or more switching transistors, before performing a reset operation on the floating diffusion node in each pixel unit in the selected row, the method further comprises turning on all switching transistors.

19. (canceled)

20. The method for reading an image sensor according to claim 18, wherein each pixel unit further comprises a selector transistor, and when reading the reset signal and the pixel signal of each pixel unit in the selected row, the selector transistor in each pixel unit of the selected row is turned on and the selector transistor in each pixel unit in rows than the selected row is turned off; or the selector transistor in each pixel unit in the K rows of pixel units remains turned on.

21. An electronic device, comprising an image sensor as claimed in claim 1.
